(19) United States
(12) Patent Application Publication
(10) Pub. No.: US 2003/0139995 A1
(43) Pub. Date: Jul. 24, 2003

(54) CyberSTEEL dynamo internet based procurement and price risk management method and trading system

(76) Inventor: Frankie Farley, Brooklyn, NY (US)

Correspondence Address: CYBERSTEEL CORPORATION, 630 OCEAN AVE 3C, BROOKLYN, NY, 11226, US

(21) Appl. No.: 09/683,591

(22) Filed: Jan. 23, 2002

(51) Int. Cl. G06F 17/60

(52) U.S. Cl. 705/37

(57) ABSTRACT

A system for transferring bill of materials data comprising; a first computer for performing computer aided design, said first computer having a computer aided design system application and a data subsystem application; a second computer for performing Internet based futures and option trading control functions; a third computer having memory for storing the bill of materials in the database; and a networking circuitry for transferring the bill of materials data among said first, second and third computers.

### BACKGROUND OF INVENTION

1. Field of Invention

The present invention relates to a method and system capable of transferring bills of materials data—materials list—between a computer aided design (CAD) computer system, such as Autodesk.RTM.'s AutoCAD.RTM., Xsteel, StruCAD, and an Internet based futures and options computer trading system.

Creating forward and futures contracts with said list and conducting a real-time auction, representing the results by a dynamic linear graph on a computer-displaying device, using said graphs as a mathematical tools to mitigate against the risks associated with steel price volatility, using said graph to design customized risks management instruments such as Caps, Floors, Swaps and Collars,

2. Description of Theory Behind Invention

CAD computer applications such as StuCAD, are used by engineers and draftspersons for designing and drawing among other things, structural steel detail drawings, such as beams and columns. Most of these applications have the capability of generating bill of materials for each design element. The bill of materials is represented by a module of information stored in memory on a user database that reflects mathematical information of said designed structural element, such as steel beams and columns.

The Theory:

The Exchange evolves from the theory that as the global population increases there is always a need for shelter and civic infrastructure along with the need for continuous repair to existing infrastructure. Steel is an integral building element of such developments. Hence, the need for steel is directly proportional to the increase in the world population. All major steel structures must originate from a detailed structural drawing that reflects the physical and chemical properties of the materials to be used for a specific project. By electronically capturing and quantifying the steel bill of materials at this juncture a logical, powerful, and cost effective production planning and trading tool evolves. Most projects may have a steel material list that is comprised of a number of different physical properties. By categorizing the materials and trading each component independently, that ultimately generates one graph that reflects the average price of all the component prices. The information is organized and centralized for use in a number of risk management applications. The ultimate objective is to generate categorized data which eventually will generate a number of market driven steel indices that will be used as trading benchmarks.

Having established the above form and functions, designing steel price risks management instruments to mitigate against steel price volatility becomes more cost effective.

Scenario 1:

A steel fabricator has won the contract to fabricate the steel structure for the new World Trade Center Complex. Before the structural steel is fabricated the fabricator needs to generate a detailed structural drawing from the approved contract drawing provided by the client's architect and structural engineers. Generally, a steel fabricator or manufacturer may have their steel detailer or estimator send the bill of material to their purchasing managers who will subsequently seek a supplier through a complicated, tedious and lengthily process. This practice limits the ability of the buyer to cost effectively buy the critical skeleton of many major civic infrastructure projects globally. The fabricator being a registered member of the host, an Internet based steel futures exchange, may have the architect electronically send the contract drawing to the host engineering department for detailing, or where detailing is already done, the material list for the host to use for designing the appropriate contract. The host engineering department will design a contract based on the project specification and schedule provided by the consumer. When the contract design is completed, the host will notify the consumer by an integrated messaging system, “You've Got STEEL”, to login to the host and review and accept or amend the contract.

Assuming the consumer does accept the contract as designed, an initial trading price is established, using a number of indexes as a benchmark including The Purchasing Magazine Steel Index (PMAG Index). The contract is then sent to the host trading floor for seller's—steel mills, processors or service centers—to bid on the contract in a number of auction format including; reverse auction. Each contract trades within a set time frame. At the end of that period the offer that reflects the lowest bid will be awarded the contract at a fixed price. The host manages the price risks associated with potential steel price volatility using the idiocies as settlement benchmarks.

The host engineering division is an integral element of the exchange and is by experienced structural steel engineers, detailers, architects, manufacturing engineers and construction managers. This division is subdivided into nine focus area including: the construction industry, transportation and infrastructure, automotive, shipbuilding, defense contractors, aerospace, oil and gas producers, electronics and appliances and furniture manufacturers. Each subdivision will be comprised of individuals who are experienced in that specific market steel procurement process and will guide the consumer in designing their contracts and risk management solution before and after the bidding process.

### SUMMARY OF INVENTION

The current invention provides a logical, simple and cost effective solution for global steel trading and price risks management when operated independently within all major internationally steel markets. The current global steel industry functions within a complex matrix of buyers and sellers using a highly fragmented supply chain with no credible steel index for settlement benchmarks. The invention also provides a solution to ultimately reduce or eliminate the existing excess steel production phenomenon. The invention further provides a platform to design solutions for the steel standardization conflicts. A key element of the invention is the evolution of a number of price risk management applications. These applications are excellent and cost effective tools for steel producers in their planning and budgeting processes.

Specifically, the method and system according to the present invention simplifies and adds logics to an inefficient steel trading system. Substantial value and order is possible by initiating the trading and price risk management process from the design stage by transferring bill of materials—material lists from a steel consumer's database in a CAD system, to an Internet based dynamic steel futures trading environment.

Because steel is a complex material having thousands of different properties and specifications, the current invention is driven by the insight that evolves from the basic theory outlined in “THE BACKGROUND OF INVENTION” above.

### BRIEF DESCRIPTION OF DRAWINGS

The invention is represented by the following attached drawings:

FIG. 1, which includes FIG. 1-1, FIG. 1-2, FIG. 1-3, FIG. 1-4, FIG. 1-5, FIG. 1-6, and FIG. 1-7 illustrates a buyer overview flow chart reflecting an embodiment of the present invention. Also, a computer based system for implementing an embodiment of the present invention,

FIG. 2, which includes FIG. 2-1, FIG. 2-2, FIG. 2-3, FIG. 2-4, FIG. 2-5, FIG. 2-6 and FIG. 2-7, illustrates a seller overview flow chart reflecting and embodiment of the present invention. Also, a computer based system for implementing an embodiment of the present invention,

FIG. 3 is a screen illustrating the computer display of a bidding event including section A, B, C, D, and E.

FIG. 4, is a screen illustrating the computer display of a plurality of displayed contracts, represented by a plurality of multi colored visual link objects including section A, B and C.

FIG. 5, illustrates the evolution of the CyberSTEEL Indices.

### DETAILED DESCRIPTION

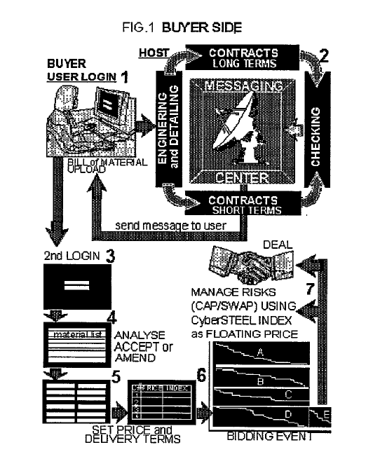

The present invention is best illustrated by the flow diagram in FIG. 1. A user 1 in a CAD/CAM environment is prompted to browse and locate module of information stored in memory on said user database that reflects a bill of material of a ferrous or non-ferrous metal construction or manufacturing project. Also, uploading via a communication channel said module of information to a host terminals in the same format as the user CAD/CAM system environment.

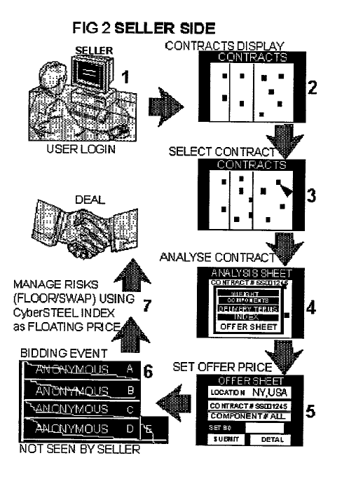

FIG. 1-2, shows a host key units, namely engineering and steel detailing, long and short-term contracts, checking and a messaging center. The units in total provide, separating said modules of information into distinct physical and chemical properties components before storing on the host CAD/CAM database. Designing futures and forward contracts for each component using guidance from the project schedule and specifications of the bill of material and storing contracts in a CAD/CAM environment on said host database. Triggering an automatic messaging system in said host computer system and whose function is to contact said user computer system and transferring data and messages via said communication channel.

FIG. 1-3, illustrates a login interface on a computer-displaying device. Prompting said user via a communication channel to input authenticating data by means of an inputting device, such as, a keyboard. to gain access to host database, enabling the user to view, accept or seek amendment to contract via interface FIG. 1-4.

FIG. 1-5, illustrates an interface on a computer-displaying device within a host computer system prompting a user to enter data by means of a computer-inputting device, such as a keyboard via a communication channel. This interface seeks or contains the following information: contract #, weight to the nearest 5 tons, location, delivery terms, index value, initial trading price buyers initial price-, contract detail button, and a submit button.

FIG. 1-6, illustrates an interface on a computer-displaying device within a host computer system prompting a user to enter data by means of a computer-inputting device, such as a keyboard via a communication channel. This interface seeks or contains data on specific components of a bill of materials contract, such as, initial bid price and index value. Said interface design is based on the number of components within a contract being traded.

FIG. 1-7, illustrates an interface on a computer-displaying device within a host computer system. reflecting a number of linear graphs that represents the bid price of each component of a bill of materials contract. Each graph, A, B, C and D, is traded independently, ultimately generating one graph E that reflects the contract price. Each graph is generated within a set time line with a specific tick. based on component weight.

FIG. 2, illustrates a login interface on a computer-displaying device. Prompting a user via a communication channel to input authenticating data by means of an inputting device, such as, a keyboard. to gain access to host database, enabling the user to view contracts displayed via a plurality of visual link objects, for potential bidders as shown in FIG. 2-2.

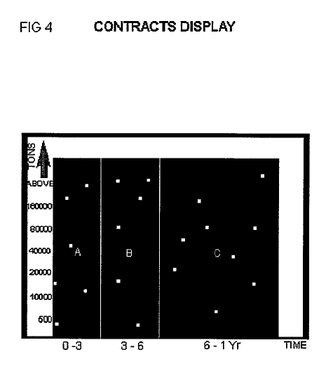

FIG. 4 shows a more detailed view of the interface design and functions.

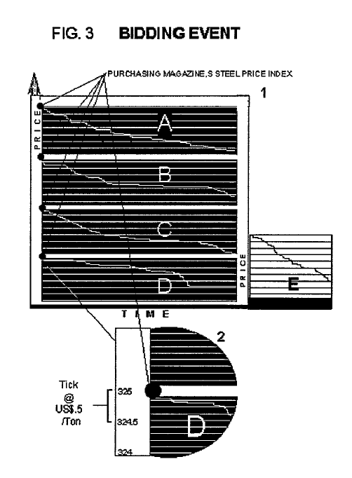

FIG. 2-3 illustrates an interface displayed on a host terminal said contract on a computer screen represented by a plurality of visual link objects colored red, yellow, green, white, blue, and orange, each color reflecting a specific characteristics of a contract. Also, a plurality of users login to said host computer database and using cursors controlled through the use of mouse devices, superimpose it over a specific colored visual link object triggering a pop-up interface that reflects a text description and other characteristics of a specific contract via FIG. 2-4

FIG. 2-5, illustrates an interface displayed on a host computer terminal representing a seller offer sheet. This interface prompts a user to enter data by means of a computer-inputting device, such as a keyboard. The entered data represents the offer price of a fraction or all of the components of a bill of materials contract.

FIG. 2-6 illustrates an interface on a computer-displaying device within a host computer system. reflecting a number of linear graphs that represents the bid price of each component of a bill of materials contract. Each graph, A, B, C and D, is traded independently, ultimately generating one graph E that reflects the contract price. Each graph is generated within a set time line with a specific tick. based on component weight.

NOTE: this display is only accessibly by the host and buyer. Seller access is blocked.

FIG. 3-1 illustrates an interface on a computer displaying device within a host computer system reflecting a bidding event and showing a number of linear graphs that represents the bid price of each component of a bill of materials contract. Each graph, A, B, C and D, is traded independently, ultimately generating one graph E that reflects the contract price. Each graph is generated within a set time line with a specific tick. based on component weight. In most case the tick movement is at US$0.5 per ton in the reverse direction

FIG. 3-2 illustrates a magnified view of a section of the bidding screen showing the initial trading price of 325 meaning component D is trading at an initial price of US$325 per ton for that specific component or segment of a materials list-bill of materials-contract. Also, the degree of the tick, US$0.5 in this case.

FIG. 4 illustrates an interface displayed on a host terminal said contract on a computer screen represented by a plurality of visual link objects colored red, yellow, green, white, blue, and orange, each color reflecting a specific characteristics of a contract. The displaying screen is divided into three distinct sections A, B, and C.

Section A represents contracts whose maturity is within 0-3 months, likewise B, 3-6 month maturity and C, 6-12 month maturity. The visual link objects represents a business transaction, each object containing critical elements of said transaction and stored on a host computer system. By superimposing a selecting device such as a mouse, over a specific colored visual link object it triggers a pop-up interface that reflects a text description and other characteristics of a specific contract via FIG. 2-4.

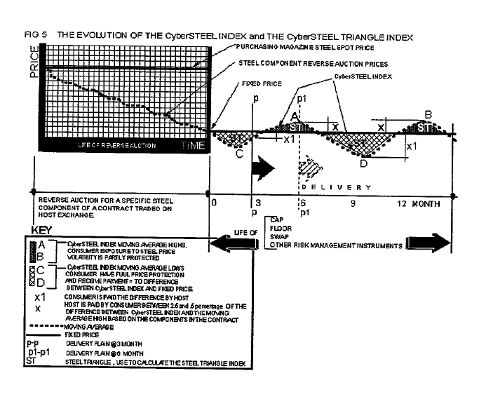

FIG. 5 illustrates the evolution of the “CyberSTEEL Index” and the “CyberSTEEL Triangle Index”.

FIG. 1-4 illustrates the general form by which the CyberSTEEL Index and CyberSTEEL Triangle Index is evolved, assuming the system functions as designed.

The present invention has been described with respect to its particular components. It is to be understood that the invention is not limited to the above-described embodiments and that various changes and modification may be made by those of ordinary skill in the art without departing from the spirit and scope of the appended claims.

1. A method and system for interfacing between a steel construction or manufacturing project design application in a CAD/CAM environment and an Internet based steel products procurement and futures and options trading system, comprising the following steps of:
(a) Prompting a user in a CAD/CAM environment to browse and locate module of information stored in memory on a user database that reflects a bill of materials of a ferrous and non-ferrous metal construction or manufacturing project,
(b) uploading via a communication channel said module of information to a host terminal in the same format as the user CAD/CAM system environment,
(c) separating said module of information into distinct physical and chemical properties components before storing on the host CAD/CAM database,
(d) Designing futures and forward contracts for each component using guidance from the project schedule and specification of the bill of materials,
(e) store designed contracts in a CAD/CAM environment on a host database,
(f) prompting a user via an communication channel to login into the host database then view, accept or seek amendment to designed contracts,
(g) prompting the user to set a spot price to initiate a dynamic trading process, predominately reversed auctions, said spot price is tied to the Purchasing Magazine Steel Index.

2. (h) displaying on a host terminal said contract on a computer displaying device, represented by visual linked objects colored red, yellow, green, white, blue, and orange, each color reflecting a specific characteristics of a contract,
(i) a plurality of users login to a host database and using cursors controlled through the use of mouse devices, superimpose them over a specific visual link object triggering a pop-up interface that reflects a text description of the characteristics of a specific contract,
(j) a plurality of users using cursor controlled through the use of mouse devices, superimposes over a specific area on the pop-up interface triggering a device driver that couples an operating system to a host computer system for the generation of programming values applied to a computer interface to establish an operating mode of a predetermined sub-element of controlling device,
(k) a plurality of users using input devices such as keyboards connected to user terminals, input data that reflects a user's desired offer price for one or more component of a bill of materials contract,
(l) the plurality of inputted data generates a linear graph on an interface at the host terminal, of which each component's resulting graph are displayed on a computer displaying device,
(m) the ultimate generation of a mean linear graph for each contract reflecting the bidding and settlement prices for the combined components of a bill of material,
(n) using the settlement prices of daily transaction to generate new floating prices dubbed the “CyberSTEEL Index”, from which the CyberSTEEL Triangle Index is evolve.
(o) using the “CyberSTEEL Index” and “CyberSTEEL Triangle Index” as a benchmark and mathematical tools to settle transactions and design price risk management solutions for trading initiated on the above platform, P1 (p) said CyberSTEEL Index represents the moving averages of a specific component of a contract's daily, weekly, monthly and annually settlement price after a reverse auction that was initiated by the Purchasing Magazine Steel price Index.

3. The method and system according to claim 1, further comprising a computer aided design system having (1) a first networking circuitry containing a user terminal, (2) a computer aided design system application at both user and host terminal and (3) a data warehouse subsystem application at both user and host terminal;
an Internet based trading floor computer system having a second networking circuitry; and communication circuitry for transferring the bill of materials data from said first network circuitry to said second networking circuitry, whereby the computer aided design system application is executed to locate the bill of materials, the data warehouse subsystem application is loaded from within the executed computer aided design system, and the loaded data warehouse subsystem application is operated from within the executed computer aided design system application to retrieve the bill of materials from the user data warehouse subsystem storage and cause the communication circuitry to the bill of materials data.

4. A system for transferring bill of materials data comprising;
a first computer for performing computer aided design, said first computer having a computer aided design system application and a data subsystem application;
a second computer for performing Internet based futures and option trading control functions;
a third computer having memory for storing the bill of materials in a database; and a networking circuitry for transferring the bill of materials data among said first, second and third computers.
